(19) United States
(12) Patent Application Publication
(10) Pub. No.: US 2010/0283558 A1
(43) Pub. Date: Nov. 11, 2010

(54) TEMPERATURE COMPENSATED TUNEABLE TEM MODE RESONATOR

(76) Inventors: Andrew James Panks, Leeds (GB); Christopher Ian Mobbs, West Yorkshire (GB)

Correspondence Address: HOWARD & HOWARD ATTORNEYS PLLC, 450 West Fourth Street, Royal Oak, MI, 48067, US

(21) Appl. No.: 12/598,280

(22) PCT Filed: Mar. 7, 2008
(86) PCT No.: PCT/GB08/00757

§ 371 Date: Jul. 28, 2010

(30) Foreign Application Priority Data
Apr. 30, 2007 (GB) 0708276.1

(51) Int. Cl. H01P 7/04

(52) U.S. Cl. 333/234; 333/222

(57) ABSTRACT

A TEM mode resonator (12) comprising a tuneable cavity (13) defined by an electrically conducting cavity wall (14), the cavity wall comprising a grounding face (15), a capacitor face (16) and a surrounding wall (17) extending therebetween; an electrically conducting resonator member (18) within the cavity extending from the grounding face (15) part way to the capacitor face; a tuning member (19) within the cavity between the resonator member and capacitor face adapted to be displaced towards and away from the capacitor face along a displacement axis to tune the resonator; the capacitor face (16) further comprising an electrically conducting temperature compensation plate (25), the temperature compensation plate being connected to the capacitor face at two spaced apart points (23, 24) and forming a bowed surface therebetween; the temperature compensation plate having a smaller coefficient of thermal expansivity than the capacitor face. The temperature compensation plate comprises an aperture (26) being arranged such that on displacement of the tuning member towards the capacitor face the tuning member is displaced towards the aperture.

The present invention relates to a temperature compensated tuneable TEM mode resonator. More particularly, but not exclusively, the present invention relates to a temperature compensated tuneable TEM mode resonator comprising a temperature compensation plate, the temperature compensation plate comprising an aperture.

WO98/58414 discloses a temperature compensated TEM mode resonator. The resonator comprises a temperature compensation plate which in use in displaced to compensate for the expansion of the resonator with temperature. Such a resonator however is not adapted to be tuned.

Tuneable temperature compensated TEM mode resonators are known. US2006/0038640 discloses an example of such a resonator. Such resonators however are complex to manufacture.

The temperature compensated tuneable TEM mode resonator according to the invention seek to overcome the problems of the prior art.

Accordingly, the present invention provides a TEM mode resonator comprising

a tuneable cavity defined by an electrically conducting cavity wall, the cavity wall comprising a grounding face, a capacitor face and a surrounding wall extending therebetween;
an electrically conducting resonator member within the cavity extending from the grounding face part way to the capacitor face;
a tuning member within the cavity between the resonator member and capacitor face adapted to be displaced towards and away from the capacitor face along a displacement axis to tune the resonator;
the capacitor face further comprising an electrically conducting temperature compensation plate, the temperature compensation plate being connected to the capacitor face at two spaced apart points and forming a bowed surface therebetween; the temperature compensation plate having a smaller coefficient of thermal expansivity than the capacitor face;
characterised in that
the temperature compensation plate comprises an aperture being arranged such that on displacement of the tuning member towards the capacitor face the tuning member is displaced towards the aperture.

The TEM mode resonator according to the invention is both temperature compensated and tuneable. It is also relatively straightforward in construction and reliable.

Preferably, the displacement axis passes through the aperture.

Preferably, the displacement axis passes through the center of the aperture.

The displacement axis can be orthogonal to the capacitor plate.

The displacement axis can extend through the center of the capacitor plate.

Preferably, the resonator member is symmetrically arranged about the displacement axis.

Preferably, the aperture and face of the tuning member facing the aperture are the same shape.

Preferably, the aperture is circular and the tuning member is cylindrical.

Preferably, the area of the aperture is larger than the area of the face of the tuning member facing the aperture.

The tuning member can connected to a displacement mechanism by a tuning arm, the displacement mechanism being adapted to displace the tuning member along the displacement axis.

The tuning arm can extend through an aperture in the capacitor plate.

Alternatively, the tuning arm can extend through an aperture in the resonator member.

Preferably, the resonator member comprises and end face at least a portion of which is parallel to the capacitor face.

The end face can comprise a recess, the tuning arm extending through an aperture in the recess.

Preferably, the displacement mechanism is adapted to displace the tuning member from a retracted position at least partially within the recess towards the capacitor plate to an extended position.

The resonator member can be an integral portion of the grounding face.

Preferably, the capacitor face is aluminium.

Preferably, the temperature compensation plate is copper.

The tuning member can be a metal

Alternatively, the tuning member is a dielectric.

The present invention will now be described by way of example only, and not in any limitative sense, with reference to the accompanying drawings in which

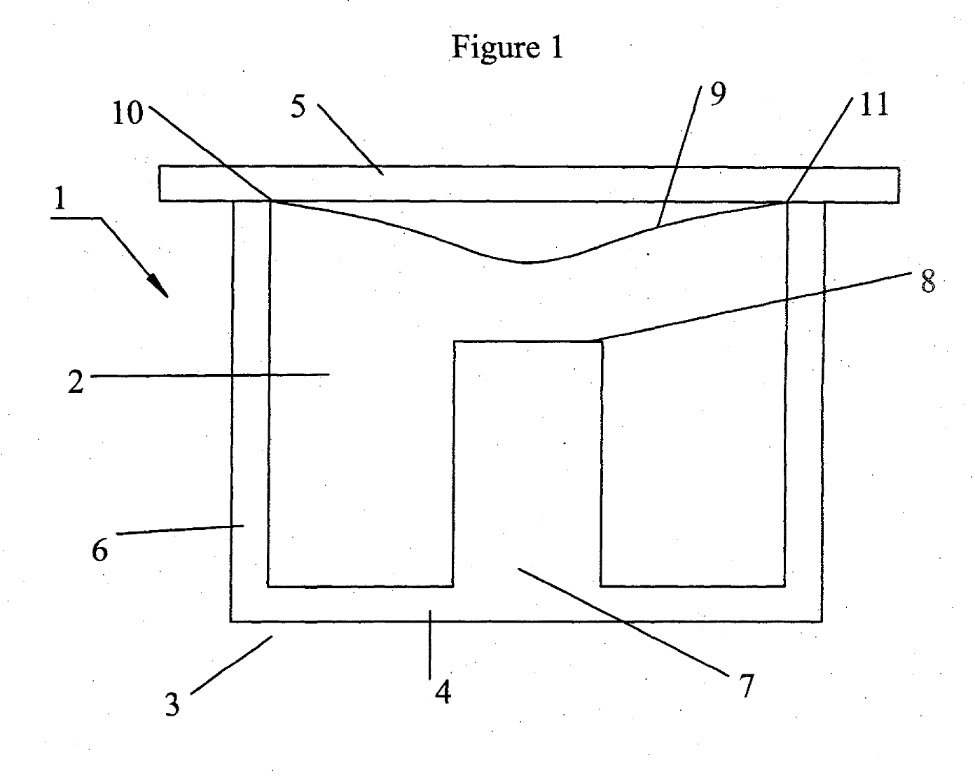

FIG. 1 shows a known temperature compensated TEM mode resonator according to the invention in cross section;

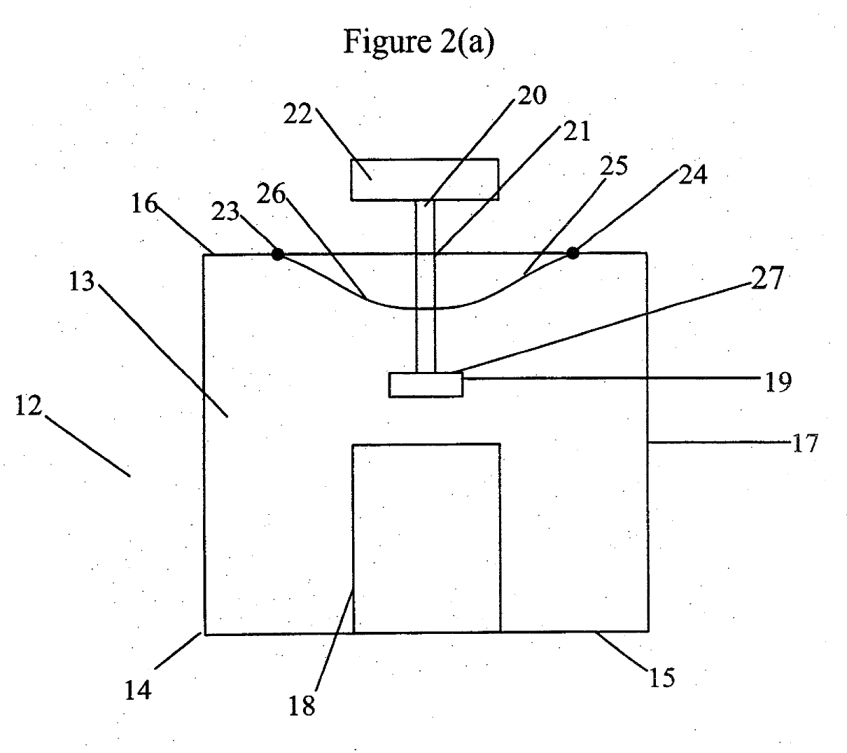

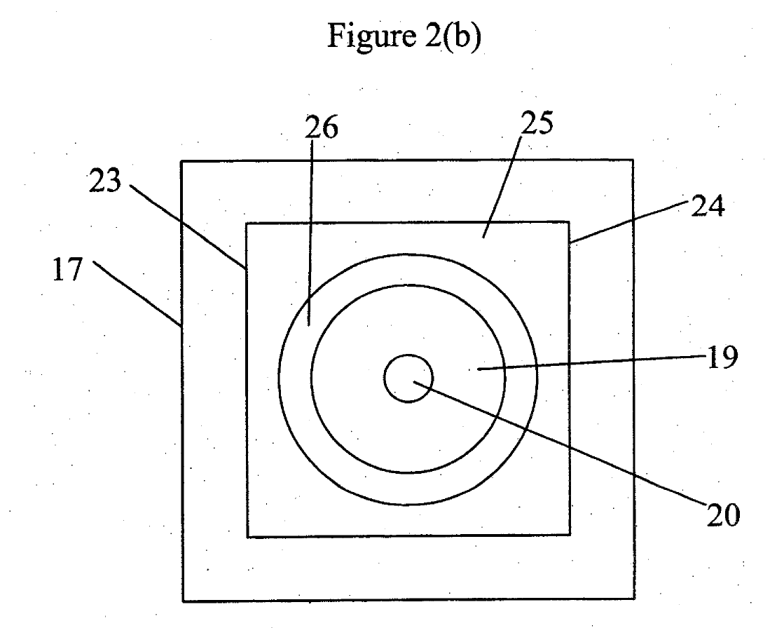

FIG. 2 shows a TEM mode resonator according to the invention in cross section and plan view;

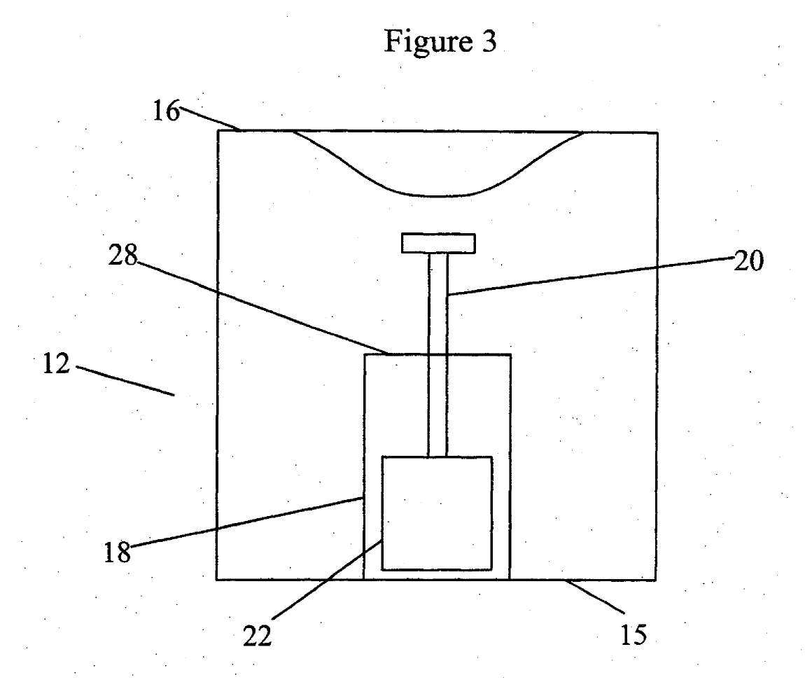

FIG. 3 shows a further embodiment of a TEM mode resonator according to the invention in cross section;

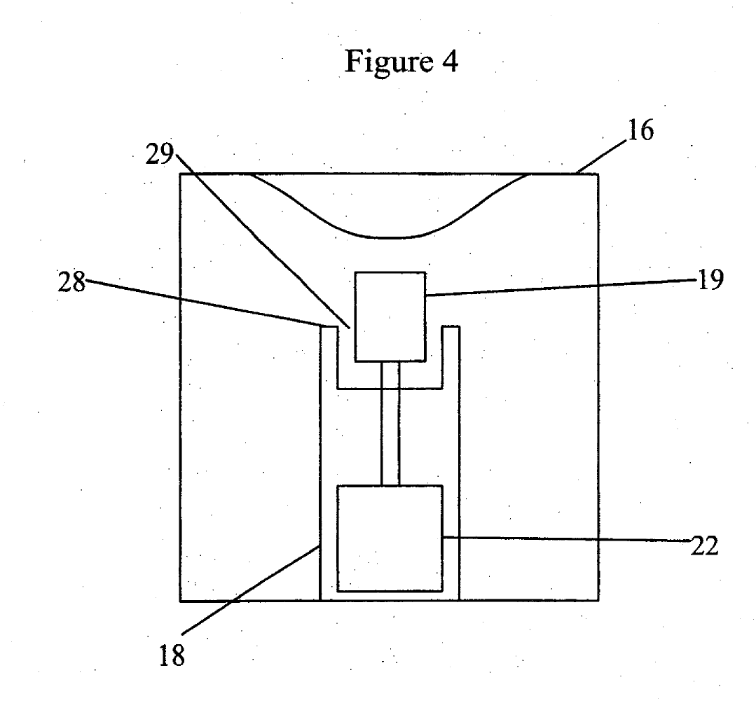

FIG. 4 shows a further embodiment of a TEM mode resonator according to the invention in cross section; and,

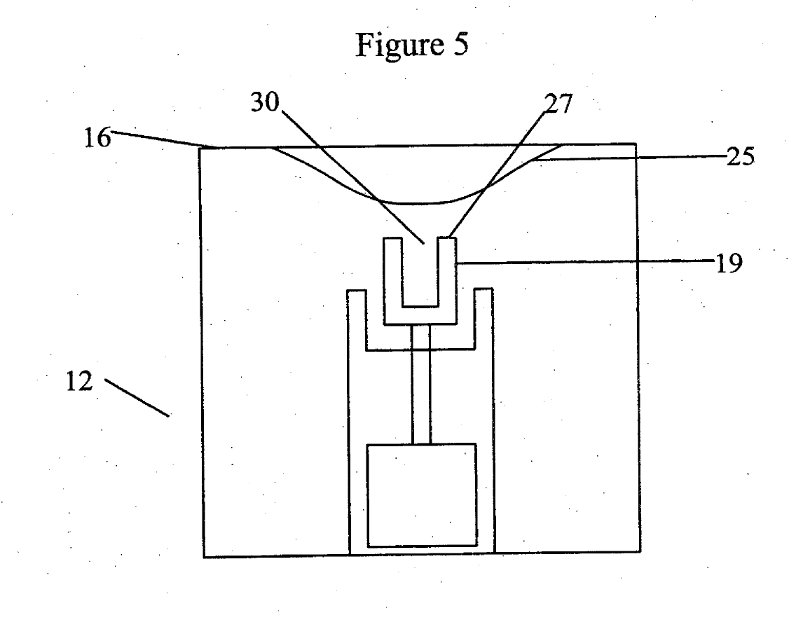

FIG. 5 shows a further embodiment of a TEM mode resonator according to the invention in cross section.

Shown in FIG. 1 is a known temperature compensated TEM mode resonator 1 according to the invention. The resonator 1 comprises a tuneable cavity 2 defined by an electrically conducting cavity wall 3. The cavity wall 3 comprises a grounding face 4, a capacitor face 5 and a surrounding wall 6 extending therebetween. An electrically conducting resonator member 7 extends from the grounding face 4 towards the capacitor face 5.

The operation of such resonators 1 is well known. The resonator member 7 and surrounding wall 6 acts as a transmission line short circuited at one end by the grounding face 4. At the other end of the transmission line the capacitor face 5 and end 8 of the resonator member 7 act as a capacitor.

The resonant frequency of the resonator 1 depends upon the length of the resonator 1 and also the effective capacitance between the capacitor face 5 and resonator member 7. Increasing either decreases the resonant frequency of the resonator 1.

As temperature increases the cavity 2 and resonator member 7 expand. The effective length of the resonator 1 therefore increases. Similarly, the effective capacitance between capacitor face 5 and resonator member 7 also increases. This is because the effective area of the capacitor increases more rapidly than the distance between the capacitor face 5 and resonator member 7. The resonant frequency of the microwave resonator 1 therefore decreases as the temperature increases. For a typical aluminium resonator 1 adapted to resonate in the GHz range, this expansion causes a drop in resonant frequency of around 22 KHz/degree C.

In order to at least partially overcome this problem the known resonator 1 includes a temperature compensation plate 9 attached to the capacitor face 5 at two spaced apart points 10,11. The temperature compensation plate 9 is slightly bowed as shown. The temperature compensation plate 9 has a smaller coefficient of thermal expansivity than the capacitor face 5. Accordingly, as the temperature rises the capacitor face 5 expands more rapidly than the temperature compensation plate 9. The bow in the compensation plate 9 is therefore reduced as its edges 10,11 are pulled part. This increases the distance between the resonator member 7 and temperature compensation plate 9. This reduces the effective capacitance so partially compensating for the increase in effective capacitance caused by the temperature rise.

Such a temperature compensation plate 9 is not suitable for temperature compensation of tunable TEM resonators. Tuneable TEM resonators typically comprise a tuning member in the gap between the capacitor face 5 and temperature compensation plate 9 and the resonator member 8. By displacing the tuning member towards or away from the capacitor face 5 one can adjust the resonant frequency. The coupling between the tuning member and capacitor face 5 strongly depends upon the distance between the capacitor face 5 and tuning member. When the tuning member is close to the capacitor face 5 the tuning member couples strongly to the temperature compensation plate 9. A small displacement of the temperature compensation plate 9 strongly affects the coupling and so the resonant frequency. In contrast, when the tuning member is remote from the capacitor face 5 the coupling is less strong and so displacement of the temperature compensation plate 9 has relatively little effect on the coupling and hence the resonant frequency. The effect of the temperature compensation plate 9 therefore depends upon the position of the tuning member. The temperature compensation plate 9 may under compensate for temperature effects when the tuning member is in one position but may over compensate when the tuning member is in a different position.

In order to correct for this known tuneable TEM mode resonators typically include a complex feedback system to displace the tuning member to correct for any over or under corrections by the temperature compensation plate 9. Such mechanisms however are complex and relatively unreliable.

Shown in FIG. 2 is a temperature compensated tuneable TEM mode resonator 12 according to the invention. The resonator 12 comprises a tuneable cavity 13 defined by an electrically conducting cavity wall 14. The cavity wall 14 comprises a grounding face 15, a capacitor face 16 and a surrounding wall 17 extending therebetween. Arranged within the tuneable cavity 13 is an electrically conducting resonator member 18. The resonator member 18 extends from the center of the grounding face 15 partially towards the capacitor face 16.

Arranged in the gap between the resonator member 18 and the capacitor face 16 is a tuning member 19. The tuning member 19 is connected to a tuning arm 20 which extends through an aperture 21 in the capacitor face 16 to a displacement mechanism 22. The displacement mechanism 22 displaces the tuning member 19 towards and away from the capacitor face 16 and resonator member 18 along a displacement axis to tune the resonator 12.

In this embodiment the resonator member 18 and grounding face IS are two separate metal pieces connected together. In use the current density in the resonator 12 is highest at the join point between the two and so in a preferred embodiment the resonator member 18 integrally extends from the grounding face 15. Similarly, in a preferred embodiment the surrounding wall 17 integrally extends from the grounding face 15 although can, in alternative embodiments, comprise one or more separate metal pieces. The capacitor face 16 is typically a separate piece which can be removed to allow access to the resonator cavity 13. In an alternative embodiment the capacitor face 16 integrally extends from the surrounding wall 17. A preferred metal for the cavity wall 14 is aluminium.

The tuning member 18 is a metal. In an alternative embodiment it is a dielectric.

Connected to the capacitor face 16 at two spaced apart points 23,24 is a temperature compensation plate 25. The temperature compensation plate 25 is slightly bowed as shown. The temperature compensation plate 25 has a lower coefficient of thermal expansivity than the capacitor face 16. Accordingly, as the temperature rises and the capacitor face 16 expands the temperature compensation plate 25 also expands but at a slower rate. The temperature compensation plate 25 is therefore drawn towards the capacitor plate 16 partially compensating for the change in resonator frequency due to the expansion of the cavity of the cavity 13 as described above.

The temperature compensation plate 25 comprises an aperture 26. The tuning arm 20 passes through the aperture 26 so that as the tuning member 19 is displaced towards the capacitor face 16 it is also displaced towards the aperture 26. As the tuning member 19 is displaced towards the aperture 26 the aperture 26 subtends a larger angle at the tuning member 19. This partly offsets the increase in coupling between the tuning member 19 and temperature compensation plate 25, so reducing the problem of the change in resonant frequency of the resonator 12 with displacement of the temperature compensation plate 25 when the tuning member 19 is close to the temperature compensation plate 25 as discussed above.

An alternative way of viewing the operation of the invention is as follows. The temperature compensation plate 25 is designed to compensate for a change in resonant frequency due to the expansion of the resonator cavity 13 with temperature. Ideally one would like the temperature compensation plate 25 to couple with the cavity 13 and resonator member 18 only. However, the temperature compensation plate 25 also couples to the tuning member 19. When the tuning member 19 is remote from the temperature compensation plate 25 this is of relatively little consequence as the coupling is weak. However when the tuning member 19 is close to the capacitor face 16 the coupling between the tuning member 19 and temperature compensation plate 25 is strong. A small displacement of the temperature compensation 25 plate to compensate for a change in volume of the resonator cavity 13 significantly changes the coupling between tuning member 19 and temperature compensation plate 25 so introducing an unwanted change of resonant frequency of the resonator 12.

Ideally one requires a temperature compensation plate 25 which couples to the resonator cavity 13 and resonator member 18 but not to the tuning member 19. The aperture 26 in the temperature compensation plate 25 serves such a function. As the tuning member 19 approaches the temperature compensation plate 25 the aperture 26 appears larger to the tuning member 19 so reducing the rate at which the coupling between the temperature compensation plate 25 and tuning member 19 increase as the two are drawn closer together. Accordingly, even when the two are close together, a displacement in the temperature compensation plate 25 to allow for an expansion in the cavity 13 produces only minimal unwanted change in resonant frequency due to the change in coupling between tuning member 19 and temperature compensation plate 25.

The optimum size of the aperture 26 compared to the size of the tuning member 19 depends upon the geometry of the resonator 12, in particular that of the tuning member 19 and aperture 26. In this embodiment the aperture 26 is circular and the tuning member 19 is a cylinder with an end face 27 facing towards the aperture 26. The displacement axis extends through the center of the aperture 26 normal to the capacitor face 16 and along the central axis of the resonator member 18. The radius of the aperture 26 is slightly larger than the radius of the tuning member 19. The aperture 26 is slightly smaller than the resonator member 18 to ensure good coupling between resonator member 18 and temperature compensation plate 25. Apertures 26 smaller than the tuning member 19 are possible but are not preferred. Apertures 26 larger than both the tuning member 19 and resonator member 18 are also possible however if the aperture 26 is too large the temperature compensation plate 25 will not adequately couple to the resonator member 18 so reducing the effect of the plate 25.

In this embodiment the capacitor face 16 is aluminium and the temperature compensation plate 25 is copper. Other combinations of metals are possible.

Shown in FIG. 3 is an alternative embodiment of a TEM mode resonator 12 according to the invention. In this embodiment the resonator member 18 comprises an end face 28 parallel to the capacitor face 16. The tuning arm 20 extends through the end face 28. In this embodiment the resonator member 18 is an integral portion of the grounding face 15 as shown. The displacement mechanism 22 is arranged inside the resonator member 18 but outside the tuneable cavity 13.

A further embodiment of the invention is shown in FIG. 4. In this embodiment the resonator member 18 comprises a recess 29 in its end face 28. The displacement mechanism 22 is adapted to displace the tuning member 19 between a retracted position at least partially within the recess 29 (as shown) towards the capacitor face 16 to an extended position.

Shown in FIG. 5 is a further embodiment of a TEM mode resonator 12 according to the invention. This embodiment is similar to that of FIG. 4 except the tuning member 19 is cup shaped with a recess 30 in the face 27 facing the capacitor face 16. The cup shape further reduces the coupling between tuning member 19 and temperature compensation plate 25.

In all of the above embodiments the displacement axis extends through the center of the aperture 26. In alternative embodiments the displacement axis is to one side of the center of the aperture 26. Embodiments in which the displacement axis passes proximate to the aperture 26 are also possible. Similarly, in alternative embodiments the displacement axis may not be strictly normal to the capacitor face 16. The displacement axis may be slightly inclined to the normal to the capacitor face 16.

In an alternative embodiment the temperature compensation plate 25 is sandwiched between the capacitor face 16 and the surrounding wall 17.

1. A TEM mode resonator comprising
a tuneable cavity defined by an electrically conducting cavity wall, the cavity wall comprising a grounding face, a capacitor face and a surrounding wall extending therebetween;
an electrically conducting resonator member within the cavity extending from the grounding face part way to the capacitor face; and
a tuning member within the cavity between the resonator member and capacitor face adapted to be displaced towards and away from the capacitor face along a displacement axis to tune the resonator;
the capacitor face further comprising an electrically conducting temperature compensation plate, the temperature compensation plate being connected to the capacitor face at two spaced apart points and forming a bowed surface therebetween;
the temperature compensation plate having a smaller coefficient of thermal expansivity than the capacitor face; and wherein
the temperature compensation plate comprises an aperture being arranged such that on displacement of the tuning member towards the capacitor face the tuning member is displaced towards the aperture.

2. A TEM mode resonator as claimed in claim 1, wherein the displacement axis passes through the aperture.

3. A TEM mode resonator as claimed in claim 2, wherein the displacement axis passes through the center of the aperture.

4. A TEM mode resonator as claimed in claim 1, wherein the displacement axis is orthogonal to the capacitor plate.

5. A TEM mode resonator as claimed in claim 4, wherein the displacement axis extends through the center of the capacitor plate.

6. A TEM mode resonator as claimed in claim 5, wherein the resonator member is symmetrically arranged about the displacement axis.

7. A TEM mode resonator as claimed in claim 1, wherein the aperture and face of the tuning member facing the aperture are the same shape.

8. A TEM mode resonator as claimed in claim 7, wherein the aperture is circular and the tuning member is cylindrical.

9. A TEM mode resonator as claimed in claim 1, wherein an area of the aperture is larger than an area of the face of the tuning member facing the aperture.

10. A TEM mode resonator as claimed in claim 1, wherein the tuning member is connected to a displacement mechanism by a tuning arm, the displacement mechanism being adapted to displace the tuning member along the displacement axis.

11. A TEM mode resonator as claimed in claim 10, wherein the tuning arm extends through an aperture in the capacitor plate.

12. A TEM mode resonator as claimed in claim 10, wherein the tuning arm extends through an aperture in the resonator member.

13. A TEM mode resonator as claimed in claim 12, wherein the resonator member comprises an end face at least a portion of which is parallel to the capacitor face.

14. A TEM mode resonator as claimed in claim 13, the end face comprising a recess, the tuning arm extending through an aperture in the recess.

15. A TEM mode resonator as claimed in claim 14, wherein the displacement mechanism is adapted to displace the tuning member from a retracted position at least partially within the recess towards the capacitor plate to an extended position.

16. A TEM mode resonator as claimed in claim 1, wherein the resonator member is an integral portion of the grounding face.

17. A TEM mode resonator as claimed in claim 1, wherein the capacitor face is aluminium.

18. A TEM mode resonator as claimed in claim 1, wherein the temperature compensation plate is copper.

19. A TEM mode resonator as claimed in claim 1, wherein the tuning member is a metal

20. A TEM mode resonator as claimed in claim 1, wherein the tuning member is a dielectric.

21. (canceled)
